(19) United States
(12) Patent Application Publication
(10) Pub. No.: US 2026/0009941 A1
(43) Pub. Date: Jan. 8, 2026

(54) LIGHT SOURCE MODULE AND DISPLAY APPARATUS

(71) Applicant: HannStar Display Corporation, Taipei City (TW)

(72) Inventors: Chia-Lin Liu, Taipei City (TW); Shih Wei Chen, Taipei City (TW); Der-Hsing Liou, Taipei City (TW)

(73) Assignee: HannStar Display Corporation, Taipei City (TW)

(21) Appl. No.: 18/945,521

(22) Filed: Nov. 13, 2024

(30) Foreign Application Priority Data
Jul. 8, 2024 (TW) 113125436

(51) Int. Cl. F21V 8/00

(52) U.S. Cl. CPC G02B 6/0036; G02B 6/0091; G02B 6/0095

(57) ABSTRACT

A light source module including a light guide cover, a plurality of optical microstructures and a first light source is provided. The light guide cover has a first surface and a groove. The first surface is adapted to be disposed toward a display surface of a display panel. The groove is recessed from an edge of the first surface. The plurality of optical microstructures are disposed on the first surface. The first light source is disposed in the groove and used to emit a first illumination light toward a first light incident surface defining the groove of the light guide cover. The first illumination light is adapted to be transmitted in the light guide cover, and the plurality of optical microstructures are adapted to deflect the first illumination light to the display surface of the display panel. A display apparatus adopting the light source module is also provided.

### CROSS-REFERENCE TO RELATED APPLICATION

This application claims the priority benefit of Taiwan application serial no. 113125436, filed on Jul. 8, 2024. The entirety of the above-mentioned patent application is hereby incorporated by reference herein and made a part of this specification.

### BACKGROUND

### Technical Field

The disclosure relates to a light source module and a display apparatus, and more particularly, to a light source mode and a display apparatus having a light guide cover.

### Description of Related Art

To meet the display needs under low ambient light conditions, a current display apparatus is equipped with a front light module. During the operation of the display apparatus, since the front light module is arranged in front of the display panel, the risk of the light guiding element being damaged by external forces is inevitably higher. To address this issue, a method of placing a protective cover on the front light module has been proposed. However, this approach increases the overall thickness, weight, and production cost of the display apparatus.

### SUMMARY

The disclosure provides a light source module and a display apparatus with a thinner and lighter appearance and lower production cost.

A light source module in the disclosure is adapted to be arranged on one side of a display surface of a display panel. The light source module includes a light guide cover, a plurality of optical microstructures and a first light source. The light guide cover has a first surface and a groove. The first surface is adapted to be disposed toward the display surface of the display panel. The groove is recessed from an edge of the first surface. The plurality of optical microstructures are disposed on the first surface. The first light source is disposed in the groove and used to emit a first illumination light toward a first light incident surface defining the groove of the light guide cover. The first illumination light is adapted to be transmitted in the light guide cover, and the plurality of optical microstructures are adapted to deflect the first illumination light to the display surface of the display panel.

In an embodiment of the disclosure, the light guide cover of the light source module further has a second surface facing away from the first surface, and the second surface is covered with an optical film or a protective film.

In an embodiment of the disclosure, the light guide cover of the light source module further has a groove bottom surface defining the groove. The groove connects the first light incident surface. The groove bottom surface is covered with a light shielding layer.

In an embodiment of the disclosure, the first light source of the light source module overlaps the light shielding layer along a normal direction of the groove bottom surface, and the light shielding layer is located between the groove bottom surface and the first light source.

In an embodiment of the disclosure, the light guide cover of the light source module further has a second surface facing away from the first surface. An orthographic projection of the groove on the second surface surrounds an orthographic projection of the plurality of optical microstructures on the second surface.

In an embodiment of the disclosure, the groove of the light source module defines a light guide portion of the light guide cover. The first light incident surface is provided on one side of the light guide portion. A second light incident surface is provided on another side of the light guide portion. The light source module further includes a second light source disposed in the groove and used to emit a second illumination light toward the second light incident surface of the light guide cover. The second illumination light is adapted to be transmitted in the light guide cover, and the plurality of optical microstructures are adapted to deflect the second illumination light to the display surface of the display panel.

In an embodiment of the disclosure, an orthographic projection of the light shielding layer of the light source module on the second surface surrounds the orthographic projection of the plurality of optical microstructures on the second surface. The second light source overlaps the light shielding layer along a normal direction of the groove bottom surface, and the light shielding layer is located between the groove bottom surface and the second light source.

A display apparatus in the disclosure includes a display panel and a light source module. The light source module is disposed on one side of a display surface of the display panel, and includes a light guide cover, a plurality of optical microstructures, and a first light source. The light guide cover has a first surface and a groove. The first surface is adapted to be disposed toward the display surface of the display panel. The groove is recessed from an edge of the first surface. The plurality of optical microstructures are disposed on the first surface. The first light source is disposed in the groove and used to emit a first illumination light toward a first light incident surface defining the groove of the light guide cover. The first light illumination light is adapted to be transmitted in the light guide cover, and the plurality of optical microstructures are adapted to deflect the first illumination light to the display surface of the display panel.

In an embodiment of the disclosure, the display panel of the display apparatus is a total reflective display panel or a transflective display panel.

Based on the above, in a display apparatus according to an embodiment of the disclosure, a first surface of the light guide cover of a light source module facing a display panel is provided with a plurality of optical microstructures and a groove. In addition to transmitting illumination light emitted by a light source arranged in the groove and deflecting it to the display panel through the optical microstructures, the light guiding cover can also protect the optical microstructures. Since the light guide cover simultaneously performs light guiding and protection functions, it not only enables the display apparatus to be thinner and lighter but also reduces its production costs.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic front view of a light source module according to an embodiment of the disclosure.

FIG. 2 is a schematic cross-sectional view of a display apparatus according to an embodiment of the disclosure.

FIG. 3 is a schematic front view of a light source module according to another embodiment of the disclosure.

FIG. 4 is a schematic cross-sectional view of a display apparatus according to another embodiment of the disclosure.

### DESCRIPTION OF THE EMBODIMENTS

Exemplary embodiments of the disclosure are now described in detail with reference to the accompanying drawings. Wherever possible, the same reference numerals are used in the drawings and the description to refer to the same or similar parts.

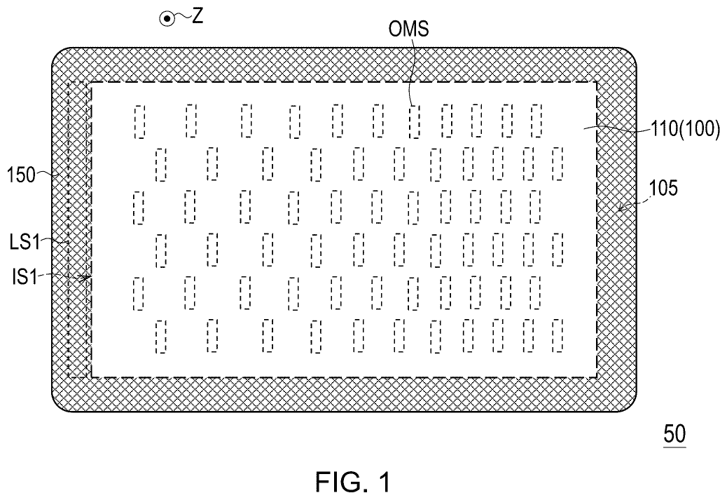

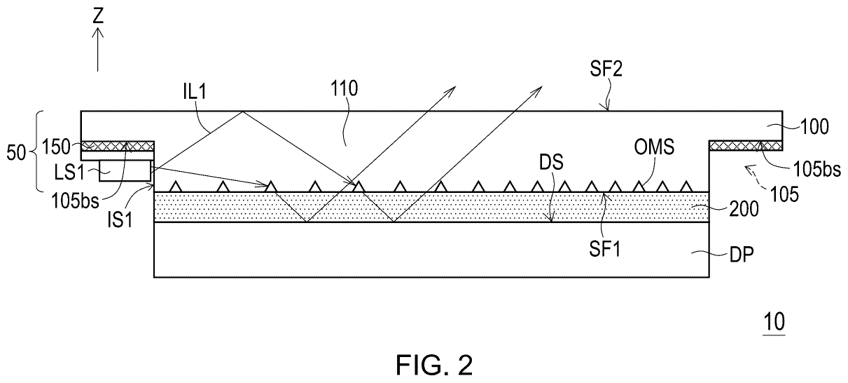

FIG. 1 is a schematic front view of a light source module according to an embodiment of the disclosure. FIG. 2 is a schematic cross-sectional view of a display apparatus according to an embodiment of the disclosure. Referring to FIG. 1 and FIG. 2, a display apparatus 10 includes a display panel DP and a light source module 50. The light source module 50 is suitable for being disposed on one side of a display surface DS of the display panel DP. In the embodiment, the display panel DP is, for example, a total reflective display panel or a transflective display panel.

The light source module 50 includes a light guide cover 100, a plurality of optical microstructures OMS, and a first light source LS1. The light guide cover 100 has a first surface SF1 and a second surface SF2 facing away from each other. The first surface SF1 is disposed toward the display panel DP and overlaps the display surface DS. The plurality of optical microstructures OMS are disposed on the first surface SF1 of the light guide cover 100. In the embodiment, the optical microstructures OMS may be recessed from the first surface SF1 into the light guide cover 100, but the disclosure is not limited thereto. In other embodiments not shown, the optical microstructures may protrude outward from the first surface of the light guide cover.

The material of the light guide cover 100 includes, for example, polymethylmethacrylate (PMMA) or polycarbonate (PC). For example, a method of forming the plurality of optical microstructures OMS on the first surface SF1 of the light guide cover 100 may include laser engraving or screen printing, but the disclosure is not limited thereto. It should be noted that in the embodiment, the cross-sectional profile of the optical microstructure OMS is exemplified by taking a triangle as an example, but the disclosure is not limited thereto. In other embodiments, the cross-sectional profile of the optical microstructure may also be semicircular, arc-shaped, polygonal, or other suitable configurations.

It is particularly noted that the light guide cover 100 further has a groove 105 recessed from an edge of the first surface SF1, and the groove 105 is provided with the first light source LS1. In detail, the light guide cover 100 further has a groove bottom surface 105bs and a first light incident surface IS1 defining the groove 105 and connected to each other. The first light source LS1 is disposed on the groove bottom surface 105bs and is located on one side of the first light incident surface IS1 of the light guide cover 100. The first light source LS1 is, for example, a light panel or a light bar, that is, the first light source LS1 may include a circuit board and a plurality of light emitting devices disposed on the (flexible) circuit board.

The first light source LS1 is adapted to emit a first illumination light IL1 toward the first light incident surface IS1. The first illumination light IL1 is adapted to be transmitted in the light guide cover 100 and deflected to the display surface DS of the display panel DP via the plurality of optical microstructures OMS on the first surface SF1. The first illumination light IL1 forms display light after being reflected by the display panel DP and is emitted through the second surface SF2 of the light guide cover 100.

In the embodiment, the user is suitable to view the display panel DP on one side of the second surface SF2 of the light guide cover 100. In order to prevent part of the first illumination light IL1 emitted by the first light source LS1 from emitting through the groove bottom surface 105bs and forming stray light that affects the display quality, a light shielding layer 150 may also be provided in the groove 105 of the light guide cover 100. For example, the light shielding layer 150 may cover the groove bottom surface 105bs, and the first light source LS1 overlaps the light shielding layer 150 along a normal direction (e.g., direction Z) of the groove bottom surface 105bs. In other words, the light shielding layer 150 is located between the groove bottom surface 105bs and the first light source LS1. The material of the light shielding layer 150 includes, for example, black resin material or other suitable light-absorbing materials.

On the other hand, in the embodiment, an orthographic projection of the groove 105 on the second surface SF2 may surround an orthographic projection of the plurality of optical microstructures OMS on the second surface SF2. Correspondingly, an orthographic projection of the light shielding layer 150 on the second surface SF2 may also surround the orthographic projection of the optical microstructures OMS on the second surface SF2.

From another point of view, the groove 105 may define a light guide portion 110 of the light guide cover 100. In other words, a portion of the light guide cover 100 surrounded by the groove 105 may be defined as the light guide portion 110, and a side surface of the light guide portion 110 facing the first light source LS1 may be defined as the aforementioned first light incident surface IS1. The first illumination light IL1 emitted by the first light source LS1 is transmitted in the light guide portion 110.

Since the plurality of optical microstructures OMS are disposed on one side of the light guide cover 100 facing the display panel DP, a user may be prevented from damaging these optical microstructures OMS when operating the display apparatus. In other words, the light guide cover 100 not only has the light guiding function but also provides a protection function for the optical microstructures OMS, which allows the display apparatus 10 to be thinner and lighter but also reduces its production costs.

Furthermore, in the embodiment, the light guide cover 100 may be bonded to the display panel DP via an adhesive layer 200. The material of the adhesive layer 200 includes, for example, optically clear adhesive (OCA) or optically clear resin (OCR), but the disclosure is not limited thereto.

Other embodiments will be enumerated below to describe the present disclosure in detail, in which the same components will be denoted by the same symbols, and descriptions of the same technical content will be omitted. Please refer to the previous embodiments for the omitted parts, which will not be described again below.

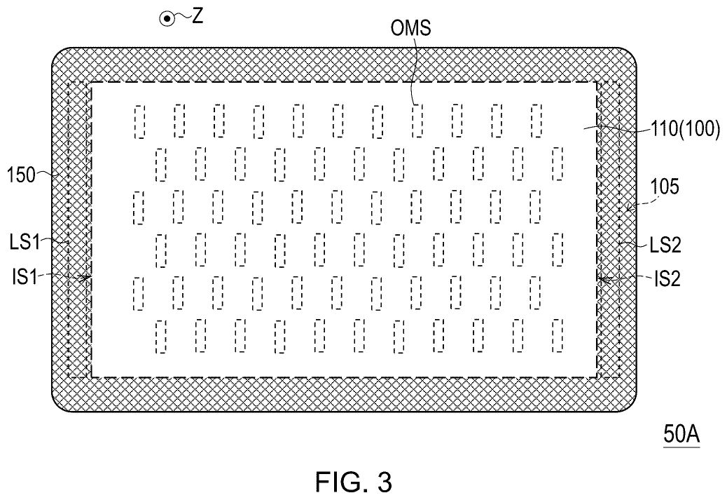

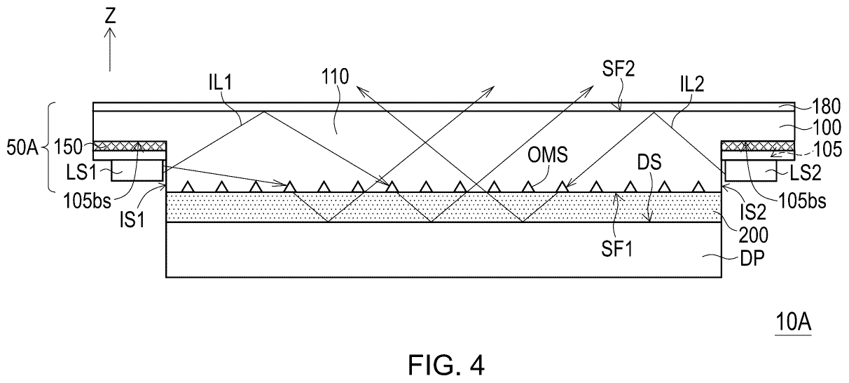

FIG. 3 is a schematic front view of a light source module according to another embodiment of the disclosure. FIG. 4 is a schematic cross-sectional view of a display apparatus according to another embodiment of the disclosure. Referring to FIG. 3 and FIG. 4, compared with the display apparatus 10 of FIG. 2, a light source module 50A of a display apparatus 10A of the embodiment may be further provided with a second light source LS2 on one side of the light guide portion 110 facing away from the first light incident surface IS1. In other words, the light guide portion 110 not only has the first light incident surface IS1 but also has a second light incident surface IS2 facing the second light source LS2.

More specifically, in the embodiment, the second light source LS2 of the light source module 50A is also disposed in the groove 105 of the light guide cover 100 and is adapted to emit a second illumination light IL2 toward the second light incident surface IS2. The second illumination light IL2 is transmitted in the light guide cover 100 and is deflected to the display surface DS of the display panel DP via the plurality of optical microstructures OMS on the first surface SF1. The second illumination light IL2 forms display light after being reflected by the display panel DP and is emitted through the second surface SF2 of the light guide cover 100. The second light source LS2 is, for example, a light panel or a light bar, that is, the second light source LS2 may include a circuit board and a plurality of light emitting devices disposed on the (flexible) circuit board.

Similar to the previous embodiment, in order to prevent part of the second illumination light IL2 emitted by the second light source LS2 from emitting through the groove bottom surface 105bs and forming stray light that affects the display quality, the second light source LS2 overlaps the light shielding layer 150 along the normal direction (e.g., direction Z) of the groove bottom surface 105bs, and the light shielding layer 150 is located between the groove bottom surface 105bs and the second light source LS2.

In the embodiment, the first light source LS1 and the second light source LS2 are respectively disposed on two opposite sides of the light guide portion 110 along a direction, but the disclosure is not limited thereto. In other embodiment, the first light source LS1 and the second light source LS2 may be respectively disposed on two adjacent sides of the light guide portion 110, and the configuration of the optical microstructures may be adjusted accordingly, which is not limited by the disclosure.

On the other hand, in the embodiment, the second surface SF2 of the light guide cover 100 may be selectively provided with a functional film 180, and the functional film 180 may be an optical film (e.g., an anti-glare film, an anti-reflective film, or a combination of the foregoing) and/or a protective film (e.g., a hard coat or an explosion-proof film). Accordingly, the durability and/or optical performances of the light guide cover 100 may be further improved.

To sum up, in a display apparatus according to an embodiment of the disclosure, a first surface of the light guide cover of a light source module facing a display panel is provided with a plurality of optical microstructures and a groove. In addition to transmitting illumination light emitted by a light source arranged in the groove and deflecting it to the display panel through the optical microstructures, the light guiding cover can also protect the optical microstructures. Since the light guide cover simultaneously performs light guiding and protection functions, it not only enables the display apparatus to be thinner and lighter but also reduces its production costs.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A light source module, adapted to be disposed on one side of a display surface of a display panel, and comprising:
a light guide cover, having a first surface and a groove, wherein the first surface is adapted to be disposed toward the display surface of the display panel, and the groove is recessed from an edge of the first surface;
a plurality of optical microstructures, disposed on the first surface; and
a first light source, disposed in the groove and used to emit a first illumination light toward a first light incident surface defining the groove of the light guide cover, wherein the first illumination light is adapted to be transmitted in the light guide cover, and the optical microstructures are adapted to deflect the first illumination light to the display surface of the display panel.

2. The light source module according to claim 1, wherein the light guide cover further has a second surface facing away from the first surface, and the second surface is covered with an optical film or a protective film.

3. The light source module according to claim 1, wherein the light guide cover further has a groove bottom surface defining the groove, the groove bottom surface connects the first light incident surface, and the groove bottom surface is covered with a light shielding layer.

4. The light source module according to claim 3, wherein the first light source overlaps the light shielding layer along a normal direction of the groove bottom surface, and the light shielding layer is located between the groove bottom surface and the first light source.

5. The light source module according to claim 3, wherein the light guide cover further has a second surface facing away from the first surface, and an orthographic projection of the groove on the second surface surrounds an orthographic projection of the optical microstructures on the second surface.

6. The light source module according to claim 5, wherein the groove defines a light guide portion of the light guide cover, the first light incident surface is provided on one side of the light guide portion, a second light incident surface is provided on another side of the light guide portion, and the light source module further comprises:
a second light source, disposed in the groove and used to emit a second illumination light toward the second light incident surface of the light guide cover, wherein the second illumination light is adapted to be transmitted in the light guide cover, and the optical microstructures are adapted to deflect the second illumination light to the display surface of the display panel.

7. The light source module according to claim 6, wherein an orthographic projection of the light shielding layer on the second surface surrounds the orthographic projection of the optical microstructures on the second surface, the second light source overlaps the light shielding layer along a normal direction of the groove bottom surface, and the light shielding layer is located between the groove bottom surface and the second light source.

8. A display apparatus, comprising:
a display panel; and
a light source module, disposed on one side of a display surface of the display panel, and comprising:
a light guide cover, having a first surface and a groove, wherein the first surface is adapted to be disposed toward the display surface of the display panel, and the groove is recessed from an edge of the first surface;
a plurality of optical microstructures, disposed on the first surface; and
a first light source, disposed in the groove and used to emit a first illumination light toward a first light incident surface defining the groove of the light guide cover, wherein the first illumination light is adapted to be transmitted in the light guide cover, and the optical microstructures are adapted to deflect the first illumination light to the display surface of the display panel.

9. The display apparatus according to claim 8, wherein the display panel is a total reflective display panel or a transflective display panel.
